(19) United States
(12) Patent Application Publication
(10) Pub. No.: US 2020/0172377 A1
(43) Pub. Date: Jun. 4, 2020

(54) DRIVE ARRANGEMENT HAVING A MOVABLE RAIL SEGMENT

(71) Applicants: thyssenkrupp Elevator AG, Essen (DE); thyssenkrupp AG, Essen (DE)

(72) Inventors: Richard Thum, Kirchheim unter Teck (DE); lgnacio Rodriguez Abad, Stuttgart (DE); Daniel Bauer, Durlangen (DE)

(73) Assignees: thyssenkrupp Elevator AG, Essen (DE); thyssenkrupp AG, Essen (DE)

(21) Appl. No.: 16/695,338

(22) Filed: Nov. 26, 2019

(30) Foreign Application Priority Data
Nov. 29, 2018 (DE) 10 2018 220 560.4

(51) Int. Cl. B66B 7/02; B66B 19/00

(52) U.S. Cl. CPC B66B 7/021; B66B 9/003; B66B 19/002

(57) ABSTRACT

A drive arrangement that includes a movable rail segment of a lift system, an electric motor configured to rotate the rail segment through a prescribed maximum movement path, and inverter units for making available electrical power to the electric motor and configured to receive a control command relating to the position of the movable rail segment and to make available electrical drive power based thereon. The drive arrangement may form at least two drive segments each of which includes one of the inverter units and a coil arrangement that is supplied with electrical power by the assigned inverter unit. Each of the drive segments may be configured such that the inverter units operate with equal priority.

This is a U.S. Non-Provisional Application, which claims priority to German Patent Application No. DE 10 2018 220 560.4, filed Nov. 29, 2018, the entire content of which is incorporated herein by reference.

### FIELD

The present disclosure generally relates to lift systems, including drive arrangements in lift systems with movable rail segments.

### BACKGROUND

The present disclosure can be applied in lift systems having at least one lift car, in particular a plurality of lift cars, which can be moved in a shaft by means of guide rails. At least one first fixed guide rail may be fixedly arranged in a shaft and oriented in a first, in particular vertical, direction; at least one second fixed guide rail may be fixedly oriented in a second, in particular horizontal, direction; at least one third, in particular rotatable, guide rail which can move with respect to the shaft may be attached to a rotational platform and can be transferred between a first position or a second position and/or an orientation in the first direction and an orientation in the second direction. The lift cabins can run in a circulating fashion like a paternoster here.

Such systems are described in part in WO 2015/144781 A1 and in German patent applications 10 2016 211 997.4 and 10 2015 218 025.5.

The essential advantage of such lift systems is the significant increase in capacity compared to conventional systems in which the lift cabins always move in the same shaft. Therefore, with a lift system as specified at the beginning it is already possible to make available a passenger conveying capacity with two shafts which would require five or more shafts in a conventional system.

This results in increased requirements in respect of fail safety. In a conventional lift system with five shafts the failure of a lift shaft means a reduction in the entire passenger conveying capacity of 20%. In the case of the lift system mentioned at the beginning, the failure of a lift shaft can mean a reduction in the passenger conveying capacity of 100%. In this context, the movable rail segments temporarily interrupt the vertical travel path in the lift shaft depending on the position and rotational position. If the drive of the movable rail segments fails in such a state, the entire lift system can fail.

Thus a need exists for a high level of fail safety for a lift system.

### BRIEF DESCRIPTION OF THE FIGURES

FIG. 1 is a perspective view of an example lift system in which a drive arrangement is installed.

FIG. 2 is a circuit diagram of an example drive arrangement.

FIG. 3 is a detailed circuit diagram of parts of the example drive arrangement.

FIG. 4 is a circuit diagram of an alternative electric motor for the example drive arrangement according to FIG. 2.

FIG. 5 is a detailed circuit diagram of another example drive arrangement in a first refinement.

FIG. 6 is a detailed circuit diagram of another example drive arrangement in a second refinement.

FIG. 7 is a detailed circuit diagram of another example drive arrangement in a third refinement.

FIG. 8 is a detailed circuit diagram of another example drive arrangement in a fourth refinement.

FIG. 9 is a detailed circuit diagram of another example drive arrangement in a fifth refinement.

FIG. 10 is a detailed circuit diagram of another example drive arrangement in a sixth refinement.

FIG. 11 is a detailed circuit diagram of another example drive arrangement in a seventh refinement.

FIG. 12 is a detailed view of an internal structure of an inverter unit of a drive segment.

FIG. 13 is a detailed view of the internal structure of an example controller with a memory for control parameters.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The present disclosure generally relates to drive arrangements having a movable rail segment in a lift system and having an electric motor for moving the movable rail segment.

The drive arrangement may comprise:

a movable, in particular rotatable, rail segment of a lift system, in particular of a lift system of the type mentioned at the beginning,

an electric motor for moving, in particular rotating, the movable, in particular rotatable, rail segment wherein the drive arrangement is, in particular, configured to rotate the rail segment through a rotation angle of less than 360°,

at least one inverter unit for making available electrical power to the electric motor.

The inverter unit is configured to receive a control command relating to the position or rotational position of the movable rail segment, and to make available the electrical drive power on the basis thereof.

Such a control command relating to the position can assume various forms. In particular, the control command can contain a specific angle specification (e.g. “90°”), merely assume in a binary fashion one of two possible values (e.g. “0” means horizontal position; “1” means vertical position) or can contain a change instruction (“0” means maintain current position; “1” means change position to the respective other value). Of course, the control command can comprise further contents. Of course, any other values which are, in particular, suitable for defining a specific position are also possible. Positions between 0° and 90° are also possible; in particular if the second direction is not oriented horizontally. The same applies of course to other positions if the third rail is moved non-rotationally.

The drive arrangement may form at least two, in particular precisely three, drive segments, and each drive segment comprises an inverter unit and at least one coil arrangement which is supplied with electrical power by the assigned inverter unit. The coil arrangements apply a drive force to, in particular, a common drive element, in particular the rotor, of the electric motor.

Each inverter unit can comprise a communication unit which is able (i.e. is designed) to receive the control command. The communication units are configured in such a way as to define, with one another, a communication unit from the set of communication units as a master communication unit and to define the remaining communication units as slave communication units.

The advantage of the method is the redundant example of the drive segments and the ability to organise the redundant units of the drive arrangement independently. In this context, a decentralised decision structure which does not require a central control unit is used. The fail safety can therefore be increased.

The electric motors for moving the movable rail segments differ significantly from drive machines for lifting and lowering conventional lift cabins. In particular, the space for movement, in particular the rotational angle, is limited; for example a maximum rotational angle of 90° is sufficient to transfer the movable rails from the vertical orientation into the horizontal orientation. In addition, the movable rail segments are connected to a multiplicity of electrical and electronic lines. When there is limited space for movement, in particular a rotational angle, this can be done by means of a drag chain. In particular, the entire cabin can also be supported in a protruding fashion next to the rotatable rail segment by means of the rotatable bearing of the electric motor.

Wherever the plural is used in the description and the claims, the formulation in the plural also includes the singular in so far as the plural is not also explicitly extended by the indication of a plurality or by a specific quantity specification. Within the scope of the present description, the term coil unit covers, in particular, a group of magnetic coils which interact in such a way that they generate, at least in one section, a magnetic field which migrates with the rotational movement of the rotor. Through this, all the coils of a coil unit are supplied with a multi-phase current by a common power inverter.

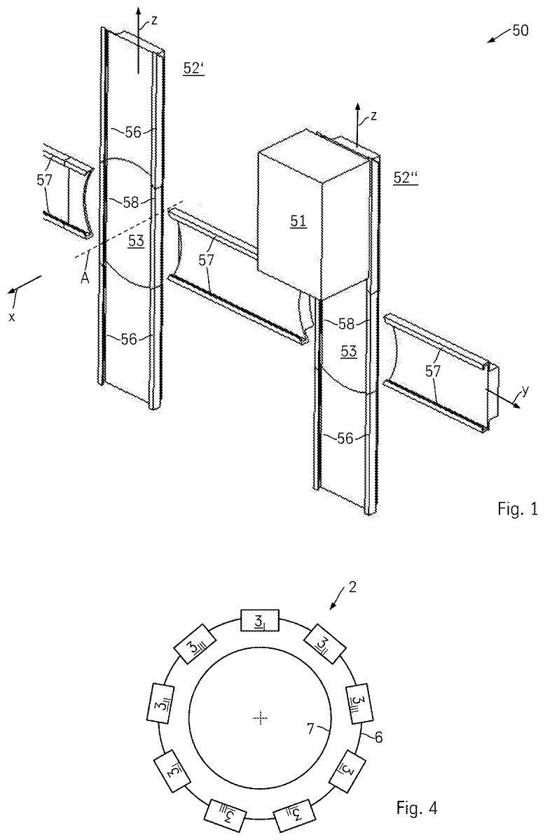

FIG. 1 shows parts of a lift system 50 mentioned at the beginning. The lift system 50 comprises first fixed guide rails 56, along which a lift car 51 can be guided by means of a backpack bearing. The first guide rails 56 are oriented vertically in a first direction z and permit the elevator car 51 to be moved between different floors. Arrangements of such first guide rails 56, along which the elevator car 51 can be guided by means of a backpack bearing, are arranged parallel to one another in two shafts 52′, 52″ running in a parallel manner. Elevator cars in the one shaft 52′ can move largely independently and unimpeded by elevator cars in the other shaft 52″ on the respective first guide rails 56.

The lift system 50 also comprises second fixed guide rails 57, along which the lift car 51 can be guided by means of the backpack bearing. The second guide rails 57 are oriented horizontally in a second direction y and permit the lift car 51 to be movable within a storey. In addition, the second guide rails 57 connect the first guide rails 56 of the two shafts 52′, 52″ to one another. Therefore, the second guide rails 57 also serve to transfer the lift car 51 between the two shafts 52′, 52″, in order e.g. to implement a modern paternoster operation.

The lift car 51 can be transferred from the first guide rails 56 onto the second guide rails 57, and vice versa, via third guide rails 58. The third guide rails 58 are rotatable with respect to a rotational axis A which is perpendicular to a y-z plane which passes through the first and second guide rails 56, 57.

All the guide rails 56, 57, 58 are attached at least indirectly to at least one shaft wall of the shaft 52. The shaft wall defines a positionally fixed reference system of the shaft. The term shaft wall also alternatively comprises a positionally fixed frame structure of the shaft which supports the guide rails. The rotatable third guide rails 58 are attached to a rotational platform 53. The rotational platform 53 is mounted by means of a platform pivot bearing which is not illustrated in FIG. 1.

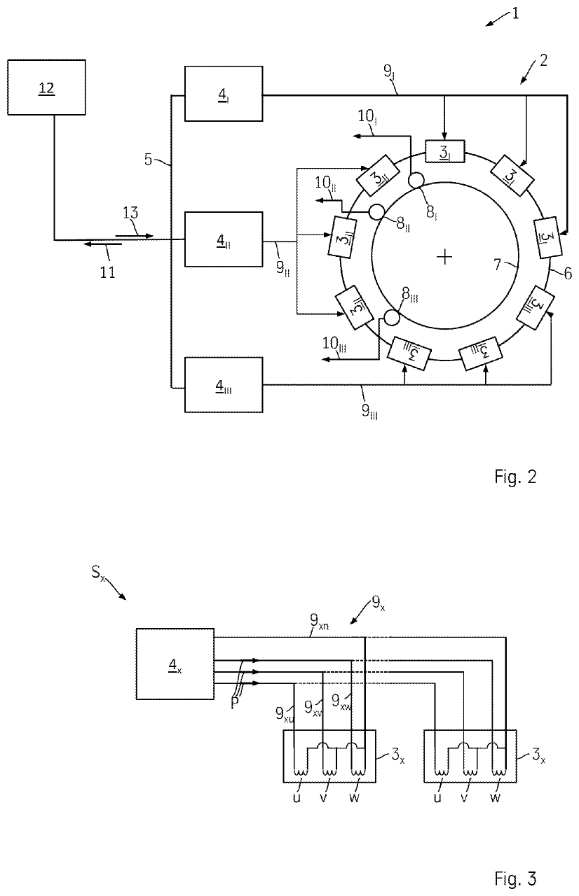

Such systems are described basically in WO 2015/144781 A1 and in German patent applications 10 2016 211 997.4 and 10 2015 218 025.5. 10 2016 205 794.4 contains in this regard a detailed description of an arrangement with an integrated platform pivot bearing and an electric motor for rotating the rotational platform, which can also be used within the scope of the present disclosure for providing bearing and as a rotary drive for the rotational platform. The lift system according to FIG. 1 then comprises a drive arrangement 1 according to the present disclosure (FIG. 2) for rotating the rotatable guide rails 58 or for rotating the rotational platform 53. WO 2018/162405 A1 describes an alternative redundancy concept for the drive arrangement 1 of such a drive arrangement.

FIG. 2 then shows the block circuit diagram of a drive arrangement 1 according to the present disclosure. The core of the drive arrangement is an electric motor 2, here a three-phase motor 2. The electric motor 2 comprises a stator 6 and a rotor 7. In one refinement, the electric motor can be an external rotor motor, wherein the rotor is arranged radially outside the stator. The stator 6 comprises a multiplicity of coil units 3. The coil units are operated with the aid of inverter units 4 which make available electrical power P for the coil units 3 via power transmission connections 9. The rotational position of the electric motor 2 is determined by means of position sensors 8 and made available for control purposes, in particular to the inverter units 4.

A superordinate control unit 12 outputs control commands 13 to the inverter units 4. For example, a control command 13 can comprise an instruction that the rotatable rails 58 are to be arranged horizontally or vertically. The inverter units 4 can emit a confirmation signal 11 to the control unit 12.

The coil units 3_{I}, 3_{II}, 3_{III} and the inverter unit 4_{I}, 4_{II}, 4_{III} which are connected thereto together form one of three drive segments. In individual refinements the three position sensors 8_{I}, 8_{II}, 8_{III} can each be assigned to precisely one of the three drive segments I, II, III. If it is subsequently a case of three segments, the minimum number is therefore meant.

FIG. 3 shows in detail the one coil unit 3ₓ, exemplary for the other coil units, of a drive segment Sₓ. Each coil unit 3ₓ comprises three coils u, v, w, which are each assigned to one phase of the multi-phase current and can be connected to one another by means of a star connection. The power transmission connection 91 comprises, for transmitting the drive power P, a multi-pole power line with lines 9ₓᵤ, 9ₓᵥ, 9_{xw} for the three phases and a neutral conductor 9ₓₘ. It is also indicated that a plurality of such coil units 3ₓ are provided for each drive segment; all the in-phase coils u, v, w of a common drive segment Sₓ are then connected to one another in parallel.

FIG. 4 shows the electric motor in a modified form. In the stator 6, the coil units 3_{I}, 3_{II}, 3_{III} of the individual drive segments I, II, III are arranged alternately in the circumferential direction. This has the advantage that when one or more segments I, II, III fail, the torque which is generated by the coils acts uniformly over the circumference on the rotor 7. Single-side loading on the mechanical components of the electric motor is therefore avoided. The lines 9 are not illustrated in this figure for reasons of clarity; however, it goes without saying that the coil units are still connected to the respectively assigned inverter unit of the same drive segment. In this respect, the circuit diagram according to FIGS. 2 and 3 can be applied.

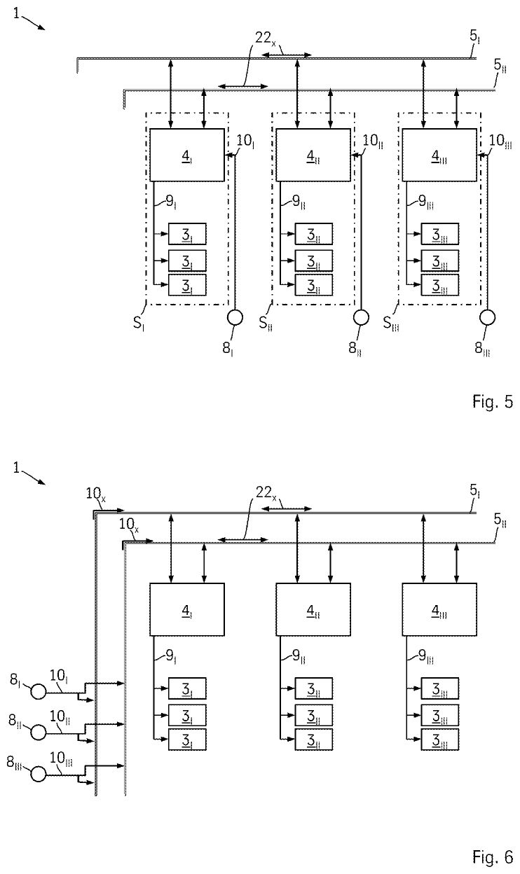

FIGS. 5 to 10 each show a schematic circuit diagram for refinements of the drive arrangement 1. Firstly, the common features of the refinements according to FIGS. 5 to 10 are explained; details on the differences in the refinements will be given subsequently.

Three inverter units 4_{I}, 4_{II}, 4_{III} are provided and are each exclusively assigned a plurality of coil units 3_{I}, 3_{II}, 3_{III}. The arrangement composed of the inverter unit 4 and exclusively assigned coil units 3 is refereed to within the scope of this application as the drive segment I, II, III. In FIG. 5, the drive segments S_{I}, S_{II}, S_{III} are represented by the dashed line. This also applies to the refinements shown in the other figures, wherein this is no longer represented explicitly in FIGS. 6 to 10.

In addition, three position sensors 8_{I}, 8_{II}, 8_{III} are provided, which make available a position sensor value 10_{I}, 10_{II}, 10_{III} of the electric motor, for example a rotary position of the rotor with respect to the stator. The position sensors 8 are not necessarily a component of one of the drive segments; however, in individual refinements the position sensors 8 can still be exclusively assigned to one drive segment (FIGS. 5, 8).

For correct operation it is necessary that at least one inverter 4 can be correctly operated with at least one coil unit 3. For this it is essential that at least this one inverter is supplied with a position sensor value 10.

Redundant first buses 5_{I}, 5_{II} are provided via which a communication of the inverters 4 with one another or a communication of the inverters 4 with the at least one superordinate control unit 12 (see FIG. 2) is carried out. The inverters exchange status values 22 with one another via the redundant first buses 5_{I}, 5_{II}, which is described in more detail below with reference to FIG. 12.

In the refinement according to FIG. 5, each of the three inverters 4_{I}, 4_{II}, 4_{III} is exclusively assigned one position sensor 8_{I}, 8_{II}, 8_{III}. For the correction operation of one of the segments S_{I}, S_{II}, S_{III} it is necessary that the position sensor 8 and the inverter 4 of a segment, for example the first position sensor 8_{I} and the first inverter 4_{I} of the first segment S_{I} function. If either the first position sensor 8_{I} or the first inverter 4_{I} fail, the first segment S_{I} is incapable of functioning. If all the drive segments are incapable of functioning in this way, the drive unit fails.

In the refinement according to FIG. 6, the position sensors 8_{I}, 8_{II}, 8_{III} are not assigned exclusively to any of the inverters 4_{I}, 4_{II}, 4_{III}. Instead, each of the position sensors 8_{I}, 8_{II}, 8_{III} is connected to each of the inverters 4_{I}, 4_{II}, 4_{III} via the two redundant first buses 5_{I}, 5_{II}. For the correct operation of the drive arrangement it is therefore necessary for at least any one of the inverters as well at least any one of the position sensors to function. In addition it is necessary that one of the two redundant first buses 5_{I}, 5_{II} is functionally capable and at the same time can transmit the position sensors values 10 from the sensors to the inverters. While in the refinement according to the FIG. 5 a drive segment already inevitably fails as a result of the failure of a sensor, in the refinement according to FIG. 6 all the drive segments position can remain capable of functioning after the failure of a position sensor.

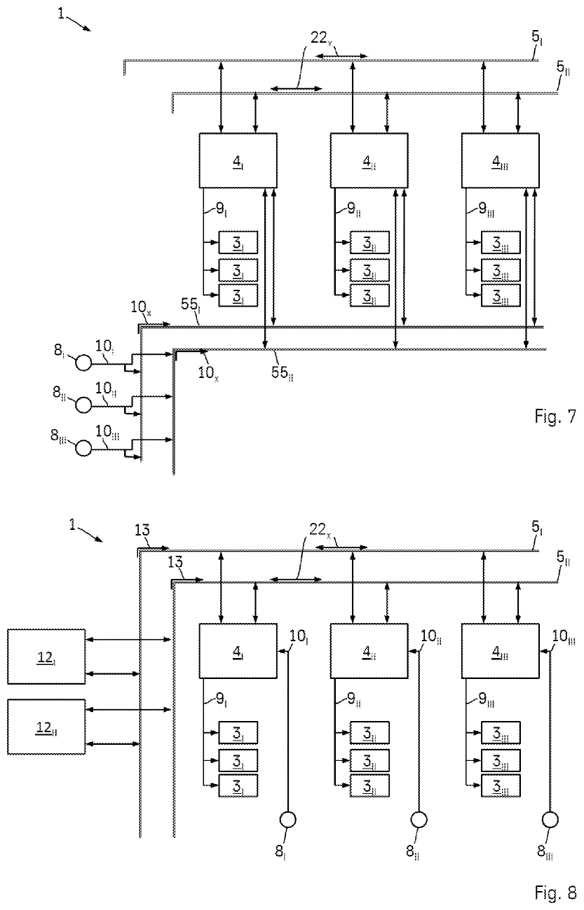

The refinement according to FIG. 7 is based on the refinement according to FIG. 6. In addition to the first redundant buses 5_{I}, 5_{II} second redundant buses 55_{I}, 55_{II} are provided which are configured for the transmission of the position sensor values 10 from the sensors 8 to the inverters 4.

The refinement according to FIG. 8 is based on the refinement according to FIG. 5. In addition, two redundant control units 12_{I}, 12_{II} are provided which send control commands 13 to all the inverters 4 via the first redundant buses 5_{I}, 5_{II}.

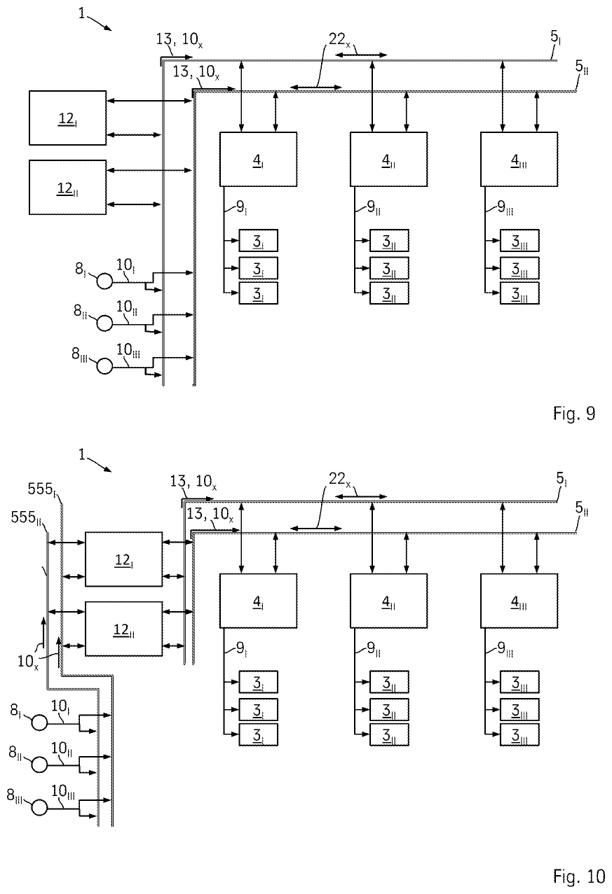

The refinement according to FIG. 9 is a combination of the two refinements according to FIGS. 6 and 8 without the position sensors 8 which are shown in FIG. 8 and are assigned exclusively to the inverters/drive segments. The position sensor values 10 can also be transmitted to the control units 12 via the first redundant buses 5_{I}, 5_{II}.

The refinement according to FIG. 10 is based on the refinement according to FIG. 9. In addition to the first redundant buses 5_{I}, 5_{II}, third redundant buses 555_{I}, 555_{II} are provided which are provided for transmitting the position sensor values 10 from the sensors 8 to the control units 12. The position sensor values 10 are passed on from the control units 12 to the inverters 4 via the first redundant buses 5_{I}, 5_{II}.

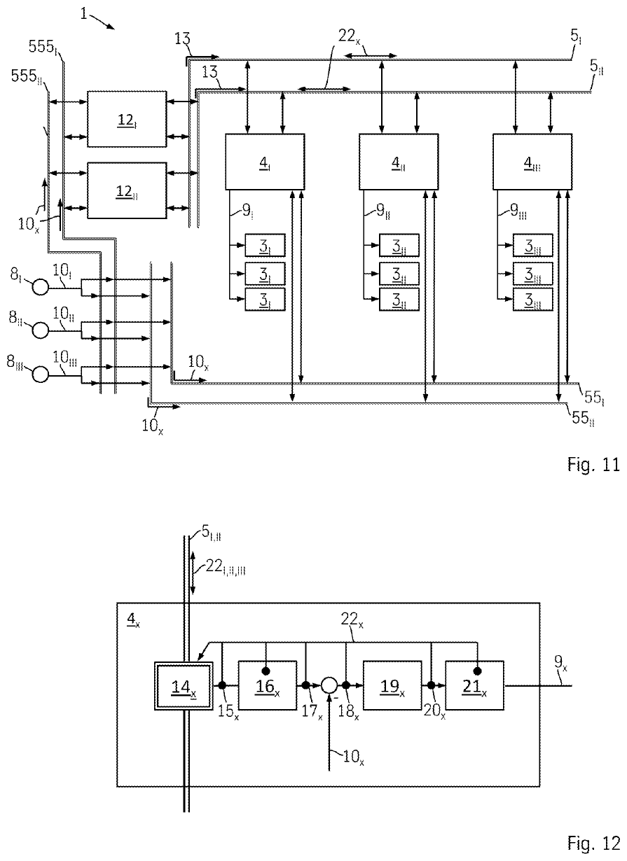

The refinement according to FIG. 11 is a combination of the two refinements according to FIGS. 10 and 7. Preceding from the refinement according to FIG. 7, the third redundant buses 555_{I}, 555_{II} are provided according to the refinement according to FIG. 10 and they transmit the position sensor values 10 from the respective position sensors 8 to the control units 12. The passing on of the position sensor values 10 from the control units 12 to the inverters 4 in accordance with the refinement according to FIG. 10 is not necessary, but is possible and can provide further redundancy.

By way of example, FIG. 12 illustrates in detail one of the inverter units 4x of the drive arrangement 1. All the inverter units 4 are of identical design and programmed identically. The inverter units can therefore be easily interchanged and the number of inverter units can be readily changed.

The inverter unit 4ₓ comprises a power inverter 21ₓ. The power inverter 21ₓ generates an output power Pₓ of the inverter unit 4ₓ, which is output in the form of a multi-phase current at the associated coil unit 5ₓ via the line 9ₓ.

A manipulated variable 20ₓ, which is made available by a first controller 19ₓ, serves as an input variable for the power inverter 21ₓ. For example, a torque value can be used as the manipulated value 20ₓ. A first control difference 18ₓ from a first reference variable 17ₓ and a first status value 10 serves as an input variable 18ₓ for the first controller 19ₓ. The first status variable is in this example a position actual value 10ₓ which is made available by one of the position sensors 8. The reference variable 17ₓ is a setpoint/actual value 17ₓ. There is provision, for example, that after deviation of the position actual value 10ₓ from the position setpoint value 17ₓ, the controller 19ₓ outputs a relatively high or relatively low torque value in order to compensate for the control difference 18ₓ. The reference variable 17ₓ is made available by a reference variable generator 16ₓ. A control signal 15ₓ which comprises, for example, the desired target orientation, which is to be set, for the rotatable rail segment serves as an input variable for the reference variable generator 16ₓ. On the basis of this control signal 15ₓ, the reference variable generator 16ₓ retrieves a stored time reference variable characteristic diagram, by means of which the reference variable 17ₓ is generated and continuously updated. The control signal 15ₓ is received by the control variable generator 16ₓ from a communication unit 14ₓ. This communication unit 14ₓ constitutes the data interface of the inverter 4ₓ with the outside and can communicate both with the communication units of the other inverter units 4 and with the control unit 12.

For example the control signal 15ₓ, the reference variable 17ₓ, the control difference 18ₓ, the manipulated variable 20ₓ and any desired variable from the sub-units (reference variable generator 14ₓ, controller 19ₓ or the power inverter 21ₓ) can be used as the status value 22ₓ. In particular, the status value 22ₓ can be a signal which explicitly specifies, or from which it can be derived from one of the other inverter units 4, whether the respective other inverter unit which is associated with the status value is operating correctly.

During the normal operation, all the drive segments S_{I}, S_{II}, S_{III} each make essential the same contribution to the overall drive of the electric motor. However, if one of the inverter units fails, it is necessary for the other drive segments to make available a correspondingly larger amount of power. Essentially, depending on the control concept the controllers of the inverter units may be able to make available this relatively large amount of power automatically. If a drive segment fails in the present case, the remaining intact drive segments each contribute 150% of the normal power, and if a further drive segment then fails the remaining intact drive segments must make available 300% of the normal power.

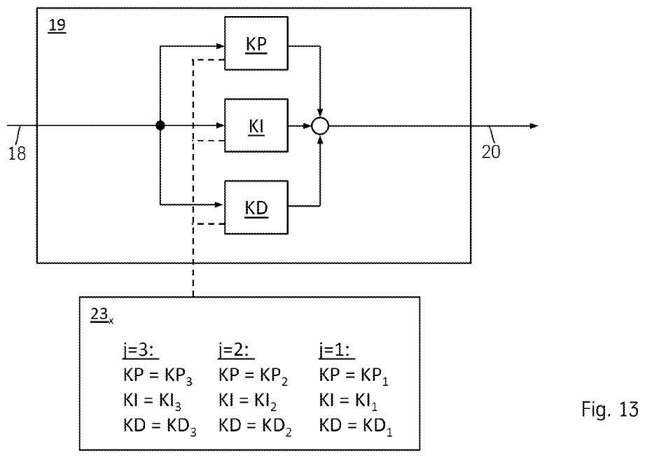

If a drive segment fails, the controlled section becomes basically more sluggish. In order to be able to compensate for this increased sluggishness, the dynamics of the respective control circuit can be increased. This may be carried out by adapting the parameters K of the controller of the intact inverter unit. FIG. 13 represents in this respect by way of example a PID controller which is characterized by the controller parameters KP of the proportionally acting controller component, KI of the integrally acting controller component and KD of the differentially acting controller component. In a memory unit, a multiplicity of suitable controller parameters are stored and can be selected depending on the operating state and applied to the controllers. The operating states are characterized here, for example, by the number j of intact drive segments: if j=3, in the present example all the drive segments are therefore intact. If j=1, two drive segments have failed. When there is a different number of drive segments, the meaning of the variable j varies correspondingly.

In order to select the controller parameters, the operating state and therefore the variable j has to be determined. In a first variant, each inverter unit can be determined automatically by observing whether, for example, a drive segment has failed. If, for example, the first controller 191 of the first inverter unit 4_{I} generates a first manipulated variable 17_{I} which continuously corresponds to approximately 150% of the rest of the power output, the first inverter unit 4_{I} can derive therefrom that one of the other inverter units 4_{II}, 4_{II} is not operating correctly.

Alternatively, the status value which is transmitted via one of the buses 5, 55, 555 can provide information as to whether one of the controllers has failed. In one variant there is provision that each intact drive segment supplies an OK value. If in one situation this value is not supplied by a drive segment, the other drive segments assume that said drive segment has failed.

From this knowledge the remaining functionally capable inverter unit 4_{II}, 4_{II} can derive that only a reduced number of coil arrangements is available for generating the drive torque, e.g. the second and third coil arrangements 3_{II}, 3_{III} of the second and third drive segments S_{II}, S_{III}.

### LIST OF REFERENCE SYMBOLS

1 Drive arrangement
2 Electric motor
3 Coil arrangement
4 Inverter unit
5 First databus
55 Second databus
555 Third databus
6 Stator
7 Rotor
8 Position sensor
9 Power transmission connection
10 Position sensor value
11 Confirmation to control unit
12 Control unit
13 Control command
14 Communication unit
15 Control signal
16 Reference variable generator
17 Reference variable
18 Control difference
19 Controller
20 Manipulated variable
21 Power inverter
22 Status value of the inverter
23 Memory
50 Lift system
51 Lift car
52 Shaft
53 Rotational platform
56 First fixed guide rail
57 Second fixed guide rail
58 Third rotatable guide rail
S Drive segment
P Electric line
j Number of intact inverter units

What is claimed is:

1. A drive arrangement comprising:
a movable rail segment of a lift system;
an electric motor for moving the movable rail segment, wherein the movable rail segment is rotatable through a prescribed maximum movement path; and
inverter units configured to make electrical power available to the electric motor, wherein each inverter unit is configured to receive a control command relating to a position of the movable rail segment and to make electrical power available based on the control command,
wherein the drive arrangement forms at least two drive segments, wherein each of the at least two drive segments includes:
one of the inverter units, wherein each of the at least two drive segments is configured such that the inverter units operate with equal priority, and
a coil arrangement that is supplied with electrical power by the respective inverter unit.

2. The drive arrangement of claim 1 wherein the at least two drive segments are configured
to obtain in parallel with one another a control difference,
to generate a manipulated variable based on the control difference, and
to operate, based on the manipulated variable, a power inverter for outputting electrical power to the coil arrangements.

3. The drive arrangement of claim 1 wherein each of the inverter units is configured to select a position sensor value independently from a plurality of available position sensor values and to operate the respective inverter unit based on the position sensor value that is selected.

4. The drive arrangement of claim 1 configured such that the inverter units are configured to detect failures of one another.

5. The drive arrangement of claim 1 wherein a failure of one of the inverter units is detectable based on either
an evaluation of status values within one of the inverter units that is intact, or
communication of the inverter units with one another.

6. The drive arrangement of claim 1 wherein a failure of one of the inverter units is detectable based on either
a comparison of a control difference with a manipulated variable, or
a status value that is or is not transmitted by one of the inverter units.

7. The drive arrangement of claim 1 wherein upon detection of a failure of one of the inverter units, a control parameter of a controller of one of the inverter units that is intact is configured to adapt control dynamics to dynamics of the drive arrangement that are changed by the failure.

8. The drive arrangement of claim 1 comprising two redundant first buses, via which two redundant first buses status values of the inverter units and/or position sensor values are communicated between the inverter units.

9. The drive arrangement of claim 1 comprising two redundant first buses, via which two redundant first buses at least one of the following is communicated:
status values of the inverter units,
position sensor values, or
control signals.

10. The drive arrangement of claim 9 comprising two redundant second buses, via which two redundant second buses at least one of the following is communicated:
status values of the inverter units,
position sensor values, or
control signals.

11. The drive arrangement of claim 10 comprising two redundant third buses, via which two redundant third buses at least one of the following is communicated:
status values of the inverter units,
position sensor values, or
control signals.

12. The drive arrangement of claim 1 wherein position sensor values are connected to one of the inverter units by way of a 1:1 wiring arrangement, wherein the one of the inverter units is configured to transmit the respective position sensor value received via the 1:1 wiring arrangement to at least one other inverter unit via a bus.

13. A lift system comprising:
a drive arrangement that comprises:
a movable rail segment of a lift system,
an electric motor for moving the movable rail segment, wherein the movable rail segment is rotatable through a prescribed maximum movement path, and
inverter units configured to make electrical power available to the electric motor, wherein each inverter unit is configured to receive a control command relating to a position of the movable rail segment and to make electrical power available based on the control command, wherein the inverter units are configured to detect failures of one another,
wherein the drive arrangement forms at least two drive segments, wherein each of the at least two drive segments includes:
one of the inverter units, wherein each of the at least two drive segments is configured such that the inverter units operate with equal priority, and
a coil arrangement that is supplied with electrical power by the respective inverter unit;
a first fixed guide rail that is fixedly oriented in a first direction;
a second fixed guide rail that is fixedly oriented in a second direction; and
a third rotatable guide rail that is attached to a rotational platform and can be transferred between an orientation in the first direction and an orientation in the second direction.

14. A lift system comprising:
a lift car;
a first fixed guide rail;
a second fixed guide rail;
a third rotatable guide rail; and
a drive arrangement for moving the third rotatable guide rail, wherein the lift car is transferable between the first guide rail and the second guide rail by way of the third rotatable guide rail.
